(19) United States
(12) Patent Application Publication
(10) Pub. No.: US 2010/0226415 A1
(43) Pub. Date: Sep. 9, 2010

(54) Mapping for MIMO Communication Apparatus

(75) Inventors: Neelesh B. Mehta, Secunderabad (IN); Dong Wang, Newark, DE (US); Hongyuan Zhang, Sunnyvale, CA (US); Andreas F. Molisch, Arlington, MA (US); Jinyun Zhang, Cambridge, MA (US)

Correspondence Address: MITSUBISHI ELECTRIC RESEARCH LABORATORIES, INC., 201 BROADWAY, 8TH FLOOR, CAMBRIDGE, MA, 02139, US

(73) Assignee: MITSUBISHI ELECTRIC RESEARCH LABORATORIES, INC., Cambridge, MA (US)

(21) Appl. No.: 12/279,914

(22) PCT Filed: Feb. 28, 2006
(86) PCT No.: PCT/US2006/006916

§ 371 Date: Aug. 19, 2008

(51) Int. Cl. H04L 27/00; H04B 1/38

(52) U.S. Cl. 375/219; 375/295; 375/260

(57) ABSTRACT

A method, MIMO communication device and electronic storage medium for mapping symbols during a duration of each plural consecutive frames of each of a plurality of first data streams (10, 12, 14, 16, 18, 20, 22, 24, 26) to frames of a plurality of second data streams (spaced-time coded streams or antenna streams); and varying the mapping during the duration of each of the plural consecutive frames of each of the plurality of first data streams (10, 12, 14, 16, 18, 20, 22, 24, 26).

### BACKGROUND OF THE INVENTION

1. Field of the Invention

This application relates to mapping signals by a multiple input multiple output communication apparatus. More specifically, this application relates to an apparatus that maps and a mapping method based on time varying mapping.

2. Description of the Related Art

Multiple antenna technique has been adopted by many of the emerging communication standards, such as 3G cellular systems, the 802.11n system and 802.16 WiMax systems. See, for example, D. Gesbert et al., “From theory to practice: an overview of MIMO space-time coded wireless systems,” IEEE Journal on Selected Areas in Communications, vol. 21, pp. 281-301, 2003, the entire contents of which are incorporated herein by reference. Theoretic analysis of communication systems has shown that deploying multiple antennas at both the transmitter side and the receiver side can provide multiple parallel channels to achieve the communication of signals. These multiple channels can be used to transmit the same signal to make the transmission less susceptible to channel fading. This is called diversity gain. On the other hand, these multiple channels can be used to transmit different signals at the same time to increase the transmission rate. This is called multiplexing gain.

Several multiple-input-multiple-output (MIMO) transmission methods have been described to achieve these two gains, or a combination thereof. Conventional space-time coded schemes can exploit the diversity gain efficiently but with no or very low multiplexing gain. In contrast, Bell Labs Layered Space-Time (BLAST) type transmission schemes can achieve a high multiplexing gain but little or no diversity gain. See, for example, G. J. Foschini, “Layered space-time architecture for wireless communication in a fading environment when using multi-element antennas,” Bell Labs Technical Journal, vol. 1, no. 2, pp. 41-59, 1996, and P. W. Wolniansky et al., “V-BLAST: An architecture for realizing very high data rates over the rich-scattering wireless channels,” Proc ISSSE-98, Pisa, Italy, September 1998, the contents of both references being incorporated in their entirety herein by reference.

In communication systems, both kinds of gains may be desirable, though a trade-off needs to be made between the two gains. In various proposals for next generation wireless communication standards, such as the IEEE 802.11n and the IEEE 802.16e, and 3GPP, several space-time coded schemes have been proposed for MIMO systems, which can achieve both diversity gain and multiplexing gain, but under certain specific conditions as will be described later. For example, in an 802.11n scheme, a space-time coded scheme has been proposed and the proposed scheme is shown in FIG. 1 and a more detailed STBC-Antenna-Mapping block diagram is shown in FIG. 2. See also, Tarokh et al., “Space-time codes for high data rate wireless communication: Performance criterion and code construction,” IEEE Trans. Information Theory, vol. 44, no. 2, pp. 744-765, 1998, and Tarokh et al., “Combined array processing and space-time coding,” IEEE Trans. Information Theory, vol. 45, no 4, pp. 1121-1128, May 1999. The entire contents of these two references are herein included by reference.

In the scheme shown in FIGS. 1 and 2, the input information bit sequence is input at an input node 9 and enters through the forward error correction (FEC) encoder 10 and the puncturer 12 to the spatial stream parser 14. The coded bit sequence is split by the spatial parser 14 into Nₛ parallel spatial streams x₁(n) to x_{Ns}(n). Each stream is interleaved by a frequency interleaver 16 and then mapped to a symbol stream. Then, the j^{th} symbol stream xⱼ, j=1, . . . , Ns, from the QAM (Quadrature Amplitude Modulation) mapping block 18 is parsed into N_{d} parallel streams xⱼ(i,k), where N_{d} is the number of data sub-channels, j is the spatial stream index, i is the OFDM (Orthogonal Frequency Division Multiplexing) symbol index and k is the data sub-channel index.

Note that the data sub-channels may also be called data-subcarriers. The word “sub-channels” is used to avoid a confusion between the terms ‘OFDM subcarriers’ and ‘data subcarriers.’ Symbols from all the spatial streams, which have the same data sub-subchannel index k (i.e., the streams xⱼ(i,k), j=1, . . . , Ns) are grouped together and input to a STBC (space-time block code) encoder 20. The STBC block 20 for a corresponding sub-carrier k outputs Nsts space-time coded streams (i,k), j=1, . . . , Nsts.

Space-time coding schemes are shown in FIGS. 3-5. For example, in FIG. 3(A), there is Ns=1 spatial stream and Nsts=2 space-time coded output streams. S1 and S2 are symbols from the same spatial stream. A complex conjugate of the symbol S1 is denoted S1* and a negative complex conjugate of the symbol S2 is denoted −S2*. In FIG. 3(B), Ns=2 and Nsts=2, the symbol S1 is from the first spatial stream and the symbol S2 is from the second spatial stream. FIGS. 3(A) and (B) show various possible mappings of the symbols S1 and S2 to the multiple antennas.

In FIG. 4(A), Ns=2 and Nsts=3, the symbols S1 and S2 are from the first spatial stream while the symbols S3 and S4 are from the second spatial stream. In FIG. 4(A), Ns=3 and Nsts=3, the symbol 51 is from the first spatial stream, the symbol S2 is from the second spatial stream, and the symbol S3 is from the third spatial stream. It is noted again various possible mappings of the symbols of the spatial streams to the multiple antennas.

In FIG. 5(A), Ns=2 and Nsts=4, the symbols S1 and S2 are from the first spatial stream while the symbols S3 and S4 are from the second spatial stream. In FIG. 5(B), Ns=3 and Nsts=6, the symbols S1 and S2 are from the first spatial stream, the symbols S3 and S4 are from the second spatial stream, and the symbols S5 and S6 are from the third spatial stream. Again, it is noted various possible mappings of the symbols of the spatial streams to the multiple antennas.

The Nsts space-time coded streams that are output for each data sub-channel k are then passed through an antenna mapping unit 4 that applies a matrix Pₖ to each sub-carrier. The output of the antenna mapping unit 4, after applying the matrix Pₖ, is given by:

[\tilde{x}ₗ(i,k), . . . , \tilde{x}_{Ntx}(i,k)]^{T}=Pₖ[\hat{x}₁(i,k), \hat{x}₂(i,k), . . . , \hat{x}_{Nsts}(i,k)]^{T}, (1)

where “T” denotes a vector transpose operation.

Different sub-carriers may use the same or different antenna mapping matrices Pₖ. These matrices are fixed within a transmission frame or a sub-frame, which are basic units of data transmission. In other words, the mapping is constant or fixed during the duration of each frame. A sub-frame is also referred to as a Transmission Time Interval (TTI) in 3GPP. In Release 6 of 3GPP, a sub-frame (or TTI) consists of 3 time slots and has a fixed duration of 2 milli-seconds. In IEEE 802.11n, each frame includes a multiple access (MAC) header, which comprises frame control information, address, and sequence control information. In 802.11n, the frame has a variable length body, which contains information specific to the frame type, and an error correcting code. The terms frame and sub-frame are used interchangeably.

For example, in the four transmit antennas case, a 4×4 Walsh-Hadamard matrix, P, shown below, can be used as Pₖ for all the data sub-channels.

$$P = \frac{1}{2} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ] .$$

Then, the symbols \tilde{x}ⱼ(i,k), k=1, . . . , N_{d}, are grouped together and input to an IFFT (inverse fast Fourier transform) conversion unit 22 to generate the time domain transmission signals. The time domain transmission signals are then amplified by a gated integrated amplifier (GI) 24 and transformed in analog signals by analog block 26 and the analog signals are output at the output terminals of the plurality of transmit antennas 6.

Due to space-time coding, this scheme can achieve the diversity gain. As the scheme can also transmit multiple spatial symbol streams simultaneously from the multiple QAM blocks 18, the scheme can also achieve the multiplexing gain.

At the receiver side (not shown), which is compatible with the transmitter side shown in FIG. 1, the signals received from the multiple receive antennas of the receiver, after down-conversion to base-band, are first input to a demodulator.

The received signal is not free of noise and also is distorted by the channel. Soft or hard decisions of the corresponding bit streams are then generated. The output of a hard decision is whether the bit received is a ‘0’ or ‘1’. On the other hand, the output of a soft decision is a probability (or a compatible measure) that the bit is a ‘0’ or ‘1’. The decision streams, which carry soft or hard decoding information, are then de-interleaved, de-multiplexed, and, finally, input to the channel code decoder to recover the input information bit stream.

When spatial multiplexing is used and the input symbols are equally likely, the optimal demodulation scheme, which is the maximum-likelihood (ML) demodulation scheme, needs to detect the symbols from all the spatial streams jointly. This makes the ML demodulation scheme prohibitively complicated and thus infeasible for practical system implementation. Thus, linear demodulation schemes, such as linear minimum mean square error estimator (LMMSE) or linear zero-forcing (ZF) estimators are usually used in practical implementations. These estimators pass the input signal vector through a spatial filter that generates the estimated symbols for each spatial stream independently. The spatial streams can be demodulated separately, or can be demodulated using a successive interference cancellation (SIC) receiver, or its variants.

It is noted that in such receivers, the multiple streams interfere with each other. Therefore, the estimated signals of different spatial streams may have different Signal-to-Interference-Noise-Ratio (SINR)s. The spatial streams with high SINR are more reliable than the spatial streams with low SINR, and lead to lower bit error and frame error rates. These SINRs depend on the channel matrix H, which relates to the links between the multiple transmitting antennas and the receiving antenna(s), and the matrix P, which is the mapping matrix between the space-time coded spatial streams and the transmit antennas. The spatial stream with the lower SINR is often the performance bottleneck and determines the overall performance of the system.

In the MIMO scheme discussed above, the antenna mapping matrix P is fixed, i.e., constant in time. This lack of change of the matrix P leads to a performance loss when linear receivers are used. Due to the channel realization, if one of the estimated spatial streams has a very low SINR, there is no mechanism available for the conventional scheme with a fixed matrix P to improve its SINR.

In fact, if the channel is slowly time-varying, it can be assumed that the channel matrix is fixed within each transmission frame. Thus, the output SINR of each estimated spatial stream does not vary over time during a frame. This is true, for example, in the IEEE 802.11n system, because the OFDM symbol duration is only 4 μs, while the Doppler frequency shift of a typical 802.11n channel model is about 5 Hz, which corresponds to a coherence duration (the duration over which the channel remains almost the same) of 80 milli-seconds. One option is to use long channel codewords that span multiple coherence intervals of the channel. However, for relatively low Doppler frequencies, this is not a feasible option due to the long codeword lengths required.

For example, in FIG. 4(A), the first spatial stream is space-time coded and the output space-time coded streams are mapped to the transmit antennas TX1 and TX2. The second spatial stream is directly mapped to the transmit antenna TX3. This mapping is fixed within a transmission frame. If the channel does not vary significantly within a frame, the SINR of the received spatial streams is also fixed. The second spatial stream (S2) is not space-time coded, has a lower diversity order and is more susceptible to harsh channel fades. Therefore, close to one half the total number of transmitted symbols are more often fading and have a lower SINR. This makes it hard for the channel decoder to recover the original information bits. An almost static channel and the unavailability of time domain diversity within each frame, thus leads to higher frame error rates in the conventional scheme.

### SUMMARY OF THE INVENTION

According to one aspect of the present invention, a MIMO communication method of wireless communication via a plurality of antennas and electronic storage medium are disclosed. The method includes mapping symbols during a duration of each plural consecutive frames of each of a plurality of first data streams to frames of a plurality of second data streams; and varying the mapping during the duration of each of the plural consecutive frames of each of the plurality of first data streams.

According to another aspect of the present invention, a MIMO communication device for wireless communication via a plurality of antennas is disclosed. The MIMO communication device includes a plurality of antennas; plural processing devices coupled to the plurality of antennas; and a mapping unit configured to map symbols within each frame of a plurality of data streams between different of antennas and the processing units and configured to varyingly map the symbols during a duration of each of plural consecutive frames.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a block diagram for a space-time coded scheme for conventional 802.11n MIMO systems;

FIG. 2 shows a block diagram of a conventional STBC-antenna-mapping block used in FIG. 1;

FIGS. 3(A)-(B) show a conventional STBC for two transmit antennas;

FIGS. 4(A)-(B) show a conventional STBC for three transmit antennas;

FIGS. 5(A)-(B) show a conventional STBC for four transmit antennas;

FIG. 6(A) shows a block diagram of a transceiver that includes a transmitter portion and a receiver portion according to one embodiment of the invention;

FIG. 6(B) shows a block diagram of a transceiver having a coding block inserted between a mapping unit and a plurality of antennas according to another embodiment of the invention;

FIG. 6(C) shows a block diagram of the transmitter portion of the transceiver shown in FIG. 6(A);

FIG. 6(D) shows a block diagram of the receiver portion of the transceiver shown in FIG. 6(A);

FIG. 6(E) shows a detailed block diagram of the receiver shown in FIG. 6(D);

FIG. 7 is a block diagram of a single carrier space-time coded transmitter portion of the transceiver according to another embodiment of the invention;

FIG. 8 is a block diagram of a multiple carrier MIMO-OFDM transmitter portion of the transceiver according to another embodiment of the invention; and

FIGS. 9-14 are graphs showing frame error rates with and without antenna hopping with various encoding methods.

### DETAILED DESCRIPTION OF THE PREFERRED EMBODIMENTS

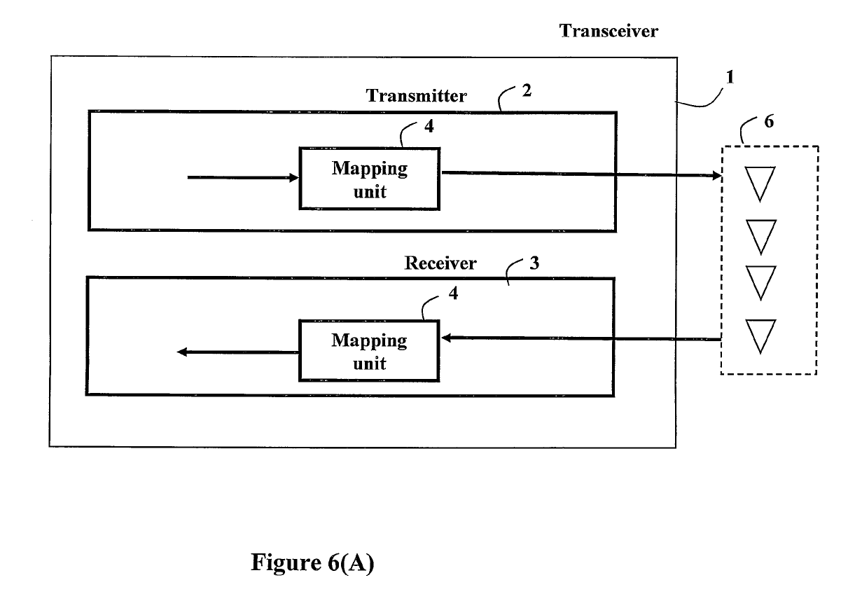

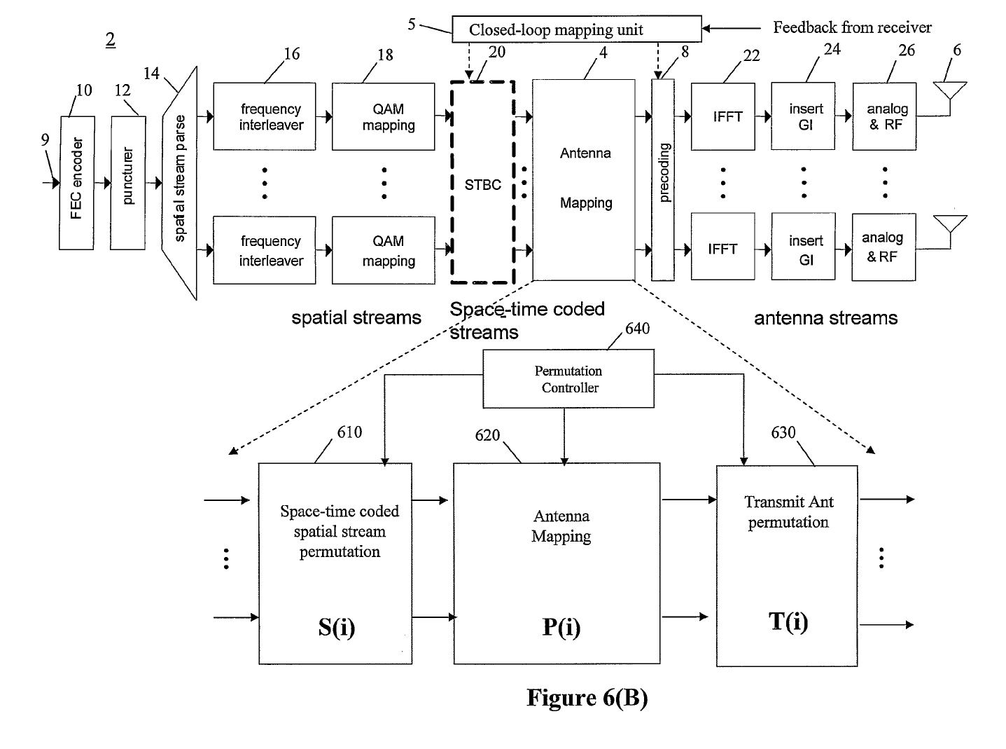

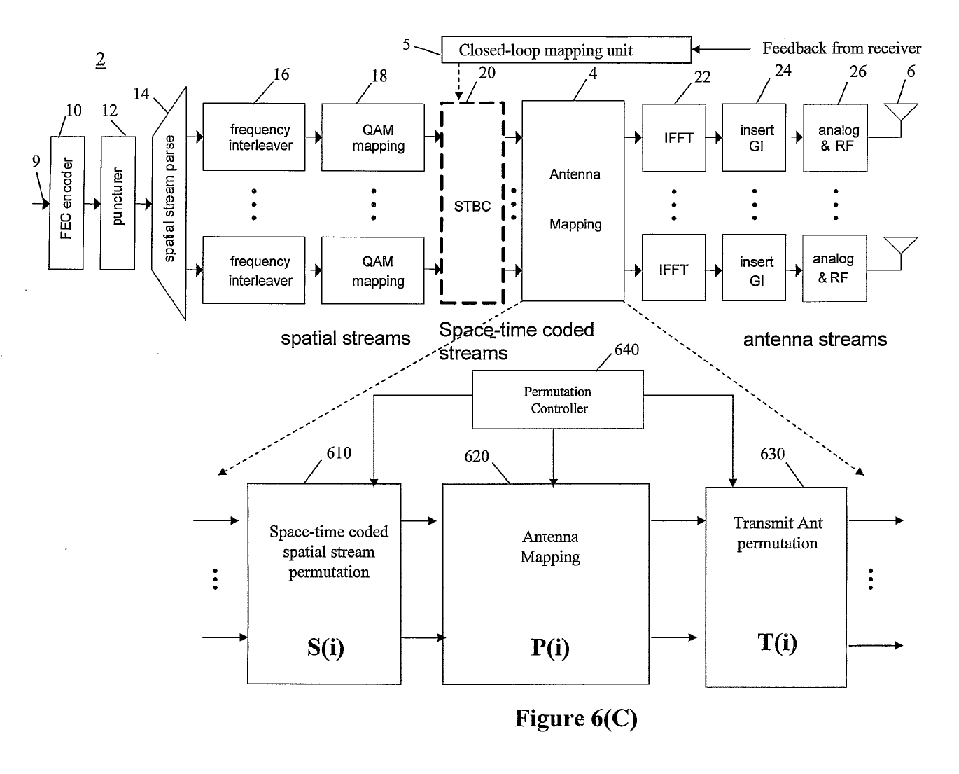

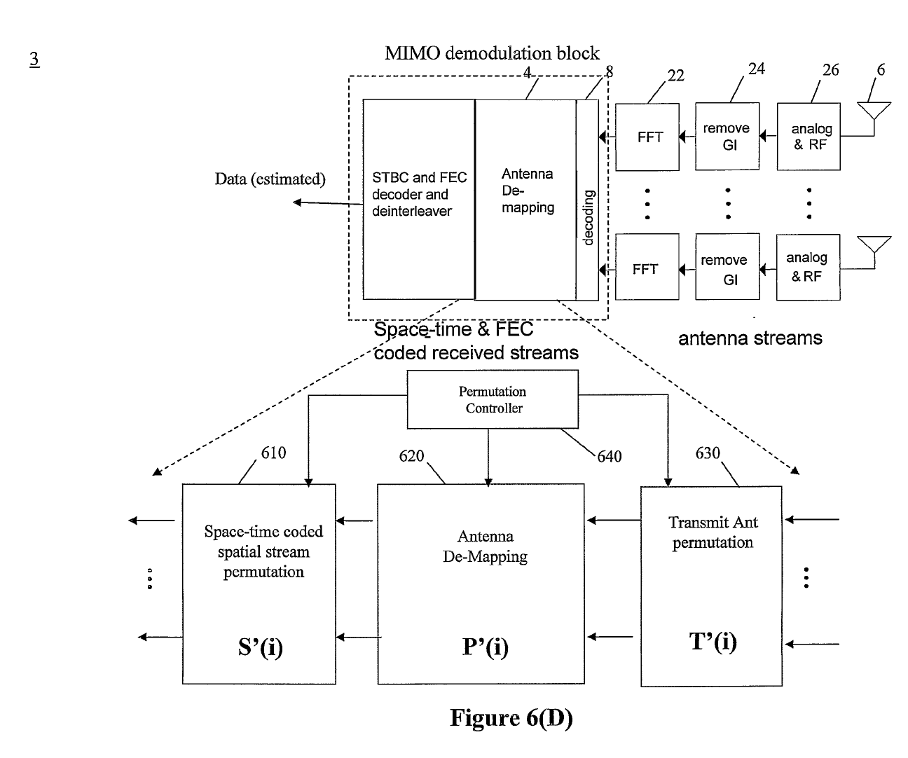

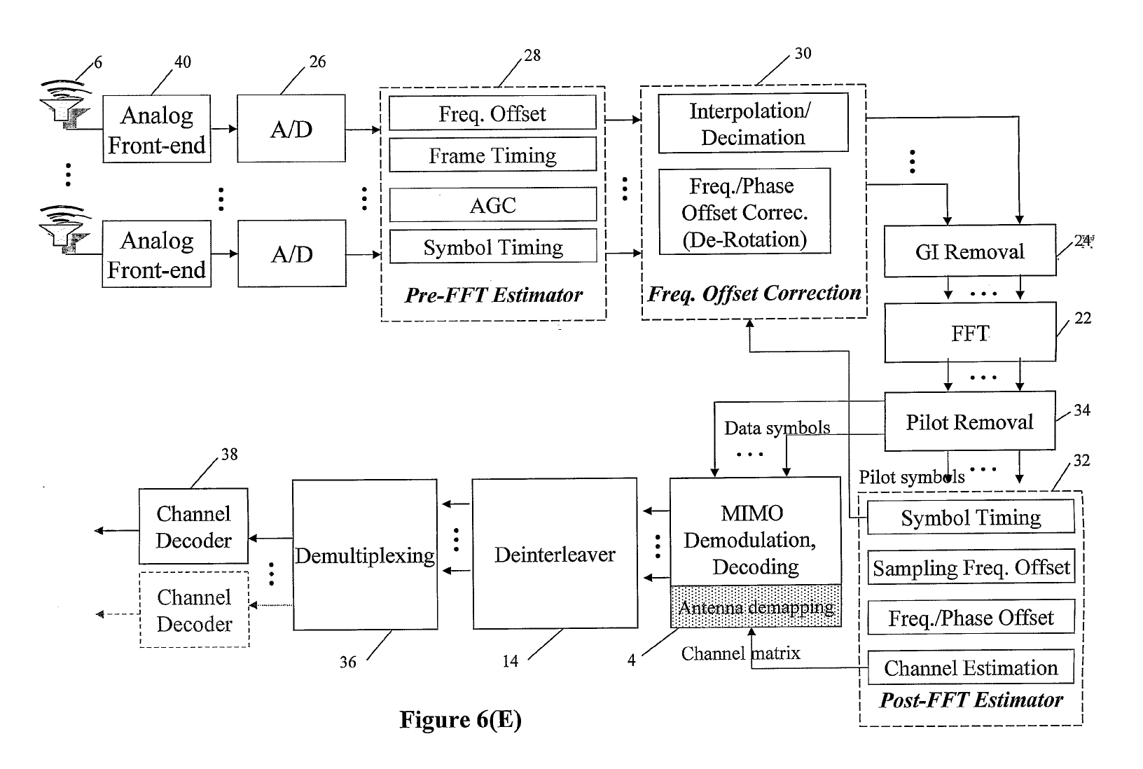

Referring now to the drawings, wherein like reference numerals designate identical or corresponding parts throughout the several views, according to the embodiment shown in FIG. 6(A), a transceiver 1 is shown to have a transmitter portion 2 and a receiver portion 3. The transceiver 1 is part of a MIMO communication apparatus according to an embodiment of the invention. An antenna mapping unit 4 is connected to multiple antennas 6 for both the transmitter 2 and receiver 3 portions. In another embodiment of the invention shown in FIG. 6(B), an intermediate block 8, for example, a unitary or not-unitary precoding block or a beamforming block or an antenna selection block or any combination of these blocks is connected between the antenna mapping unit 4 and the multiple antennas 6. It is noted that although FIG. 6(A) shows the transceiver 1 having the transmitter and the receiver portions, each of the transmitter and receiver portions can be implemented to function as a stand alone device. For this reason, it is understood in the following that the term “communication device” refers to any of a transmitter, a receiver, or a transceiver and thus, the mapping method described next applies to the communication device. It is also noted that the transmitter, the receiver, and the transceiver can be implemented, for example, as a base station that is part of the MIMO communication system, as a mobile communication terminal, or as any known device that exchanges data with another device. The mapping method described next also applies to any communication protocol used by the transmitter, receiver, and/or transceiver, as for example 3G cellular systems, the 802.11n systems and the 802.16 WiMax systems. The mapping method is not limited to the above known systems, but is applicable to any system that maps signals. Also, the method can be implemented in an apparatus that is part of a network which does not implement the method. For example, a mobile communication terminal can support the mapping method described next even if the base stations constituting the network do not support the mapping method, and vice versa.

In the following, a description of transmitting a signal by the transmitter portion 2 of the transceiver 1 is explained in more detail with regard to FIG. 6(C). The embodiment of FIG. 6(C) is not limited to the transmitter portion 2 of the transceiver 1 shown in FIG. 6(A) but is understood to also apply to a stand alone transmitter.

According to FIG. 6(C), a signal to be transmitted by the transmitter part 2 of the transceiver 1 is encoded into multiple streams, each stream including multiple frames. A frame or a sub-frame is a basic continuous transmission unit. Each frame includes a plurality of symbols. A sub-frame is also referred to as a Transmission Time Interval (TTI) in 3GPP. In Release 6 of 3GPP, a sub-frame (or TTI) consists of 3 time slots and has a fixed duration of 2 milli-seconds. In IEEE 802.11n, each frame includes multiple access (MAC) header, which comprises frame control information, address information, and sequence control information. In 802.11n, the frame has a variable length body, which contains information specific to the frame type, and an error correcting code; the maximum length of a frame at the MAC layer is 8191 bytes. The IEEE 802.16 standard specifies a frame duration of 5 ms. The terms frame and sub-frame are used interchangeably.

Each of the symbols is mapped to the multiple antennas 6, for example based on an equivalent mapping matrix \hat{P}, while varying the equivalent mapping matrix \hat{P} over a duration of a single frame or each of plural consecutive frames, so that the symbols of each frame are mapped to different frames of different antenna streams that are transmitted by different antennas of the multiple antennas 6. In other words, symbols within each of plural consecutive frames of each of first data streams (space-time coded streams or antenna streams in FIG. 6(C)) are mapped to frames of a plurality of second data streams (space-time coded streams or antenna streams in FIG. 6(C)). The mapping is varied during the duration of each of the plural consecutive frames of each of the plurality of first data streams. One example of mapping as noted above is based on the equivalent mapping matrix. However, other mappings know by one of ordinary skill in the art may be used, as for example a pseudo-random sequence. For the sake of simplicity, the mapping based on the equivalent mapping matrix is discussed next but the invention is not limited to this mapping.

The first data streams may be generated by processing units (any one or combination of elements 10, 12, 14, 16, 18, 20, 22, 24, and 26 in FIG. 6(C)) and the mapping may be performed by the mapping unit 4. Optionally, when a communication device includes the transmitter portion shown in FIG. 6(C) and functions as a transmitter, an input signal is input to an input terminal 9 of the communication to be encoded by the encoder 10 prior to being mapped by the mapping unit 4. Also, the mapped antenna streams may be converted to ‘time domain’ signals by the conversion unit 22. If the communication device discussed above functions as a receiver as shown in FIG. 6(D), then, optionally, the communication device receives plural signals at the plurality of antennas and the fast Fourier transform (FFT) conversion unit 22 converts the received signals to the frequency domain to produce plural antenna data streams for mapping by the mapping unit 4. In addition, the mapped streams may be decoded by decoder 10 to generate an output signal. In another embodiment, the communication device functions as a transceiver and each unit and step discussed above with reference to the communication device functioning as the transmitter or the receiver are part of the transceiver.

A description of receiving a signal by the receiver portion 3 of the transceiver 1 is the reverse of the transmitting description as will be understood by one of ordinary skill in the art. FIG. 6(D) shows a block diagram of the receiver portion 3 of the transceiver 1 shown in FIG. 6(A). Multiple (but different) copies of the transmitted signal are received by the multiple antennas 6. These copies of the signal are amplified by a low noise amplifier, bandpass filtered to remove out of band noise, down-converted to baseband, and digitally sampled by an analog to digital converter (ADC). As will be appreciated by persons skilled in the art, the digital sampling need not always happen at baseband. An intermediate frequency version of the signal may also be digitally sampled and then processed. The signal received in a guard interval is discarded, and is followed by an FFT block processing. The multiple received streams are then passed to a MIMO demodulation block 4 that performs the task of extracting the data transmitted from the multiple received signals. The MIMO demodulation block 4 removes pre-coding, does antenna demapping, deinterleaving, FEC decoding and demodulation as shown in FIG. 6(E).

As will be appreciated by persons skilled in the art, it is advantageous to often combine the various tasks such as precoding, demapping, FEC decoding to improve receiver performance. FIG. 6(E) shows a general MIMO demodulation block 4 in which these processes can happen serially, as was shown in FIG. 6(C), or together. FIG. 6(E) shows optional pre-FFT estimator block 28, frequency offset correction block 30, post-FFT estimator block 32, a pilot removal block 34, a demultiplexing block 36, and channel decoders 38. In addition, FIG. 6(E) shows optional analog front-end blocks 40.

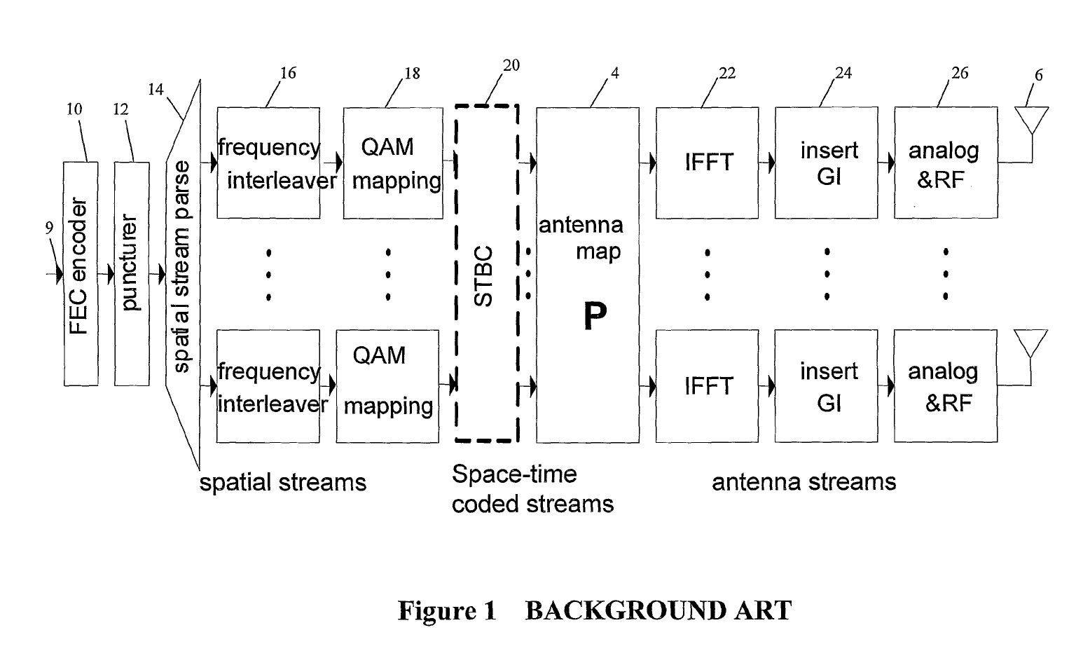

Compared to a conventional space-time coded transmission scheme, in which a signal mapping matrix is fixed during the duration of a frame, i.e., the mapping matrix P shown in FIG. 1 is constant over the duration of the frame, a new mapping in which the mapping is not fixed during the frame or plural consecutive frames is described next.

The novel mapping method involves changing intentionally and in a predefined manner, the mapping between symbols of space-time encoded streams and symbols of the plural antenna streams that correspond to the plurality of antennas 6. The mapping is performed during the single frame or each of plural consecutive frames, so that a SINR of each estimated spatial stream changes from one space-time coded block to another space-time coded block during the duration of the same frame.

By changing the mapping during the duration of the single frame or each of the plural consecutive frames in the transmitter portion 2, a receiver portion of another transceiver, which receives the signals from the transmitter portion 2 of the transceiver 1, “sees” a “time-varying” channel, and can exploit a time-diversity of the channel to improve a decoding performance. It is noted that this new mapping method is implemented in this embodiment as an open loop method as the method does not require feedback information from the receiver portion of the other transceiver.

However, in another embodiment of the invention the method is implement based on a closed-loop mechanism, such that the transmitter portion of the transceiver 1 requires feedback information from the receiver portion of the other transceiver that receives the information from the transceiver 1. The information is used to change the mapping matrix dynamically. A closed-loop feedback 5 unit performs the task of converting the received feedback into information used by the STBC 20 in FIG. 6(C) or block 8 in FIG. 6(D), for example.

The mapping method described based on the transmitter portion 2 shown in FIG. 6(C) achieves a high performance even when used in a conventional system and does not always require any alterations in for training, automatic gain control (AGC) settings, etc.

Although a random beamforming scheme varies transmit amplitude associated to the transmitted streams in a pre-determined fashion, the random beamforming scheme is different from the method of this embodiment because the random beamforming scheme is designed for multi-user diversity. The random beamforming is designed to select one out of many possible nodes for transmission and requires feedback about the channel state from all the nodes. Thus, the random beamforming scheme is not a time-diversity enhancing technique, unlike the new method of the embodiment of this invention.

The equivalent mapping matrix \hat{P} of the embodiment shown in FIG. 6(C) changes over the duration of the single frame or each of the plural consecutive frames, according to a predefined pattern assigned to that the single frame or to each of the plural consecutive frames. Examples of the predefined pattern are shown below. However, the possible predefined patterns are not limited to those examples. Any variation of the equivalent mapping matrix during the single frame or the plural consecutive frames can be used as the predefined pattern. Also, the changing of the equivalent matrix may have a periodicity within the single frame or across the plural consecutive frames.

The predefined pattern can be exchanged between the transmitter portion of the transceiver 1 and the receiver portion of the other transceiver at the beginning of the communication, or can be transmitted to the receiver portion of the other tranceiver by the transmitter portion of the transceiver 1 during each frame or during each frame of the multiple frames. The receiver portion of the other transceiver may also determine the predefined pattern on its own without any assistance from the transmitter portion of the transceiver 1.

The transmitter portion 2 shown in FIG. 6(C), instead of using a fixed antenna mapping matrix P, as the conventional art does, uses the time varying equivalent mapping matrix \hat{P}. For example, the equivalent mapping matrix \hat{P} of the transmitter portion 2 of FIG. 6(C) may include (1) a space-time encoded spatial stream permutation matrix S(i) that is applied by a unit 610, and/or (ii) an antenna mapping (spatial steering) matrix P(i) that is applied by a unit 620, and/or (iii) a transmit antenna permutation matrix T(i) that is applied by a unit 630 to the spatial streams. A permutation controller 640 may include a matrix combining unit configured to decide which combination of the matrixes (1)-(3) is selected. Alternatively, the permutation controller 640 itself decides which combination of the matrixes (1)-(3) to be used. All of the matrices may vary according to the pre-defined pattern over the duration of the single frame or the plural consecutive frames, i.e., the matrices are functions of the space-time block index i in a single transmission frame. In another embodiment, the equivalent mapping matrix \hat{P} cyclically varies over the duration of the single frame or the plural consecutive frames.

The matrices S, P, and T are only required to be non-singular, but it is often advantageous to make the matrices unitary or semi-unitary. A non-singular mapping unit and a unitary or semi-unitary mapping unit that are part of the mapping unit 4 decide which kind of mapping matrix to be applied. By way of example, the term “unitary” matrices is used in the following, without restricting the invention to this specific case. Also, it is possible to make any of the S and T matrices an identity matrix. According to one embodiment of the present invention, S(i) is an Ns by Ns unitary matrix, where Ns is the number of space-time coded spatial streams, and the matrix S(i) belongs to a set Ω. The matrix P(i) is an Ns by Nt semi-unitary matrix, where Nt is the number of transmit antennas, and P(i) belongs to the set Φ. T(i) is an Nt by Nt unitary matrix and belongs to the set Ψ.

The permutation controller 640 of the transmitter portion 2 selects the permutation matrices S(i), P(i) and T(i) for the i-th space-time coded block transmission based on the pre-defined permutation pattern, which is also known to the receiver portion of the other tranceiver. The permutation controller 640 changes, over the duration of the single frame or each of the plural consecutive frames, one of the S, P, and T matrices, a combination of the S, P, and T matrices, or all the matrices. More specifically, the permutation controller 640 changes one of the matrices S, P, T, SP, ST, PT, SPT. The matrices can be changed concurrently or one at a time. In this way, the product of the S, P and T matrices changes over the duration of the single frame or the plural consecutive frames.

In another embodiment, the permutation controller 640, over the duration of the single frame or each of the plural consecutive frames, changes one or a plurality of the matrices included into the equivalent mapping matrix \hat{P} a number of times that is equal to the number of antennas. However, for practical reasons or due to the specific structure of the STBC, the permutation controller 640 changes one or the plurality of the matrices included into the equivalent mapping matrix \hat{P} a number of times that is less than or greater than the number of antennas. According to one embodiment of the present invention, the equivalent mapping matrix changes at least twice during the single frame or each of the plural consecutive frames.

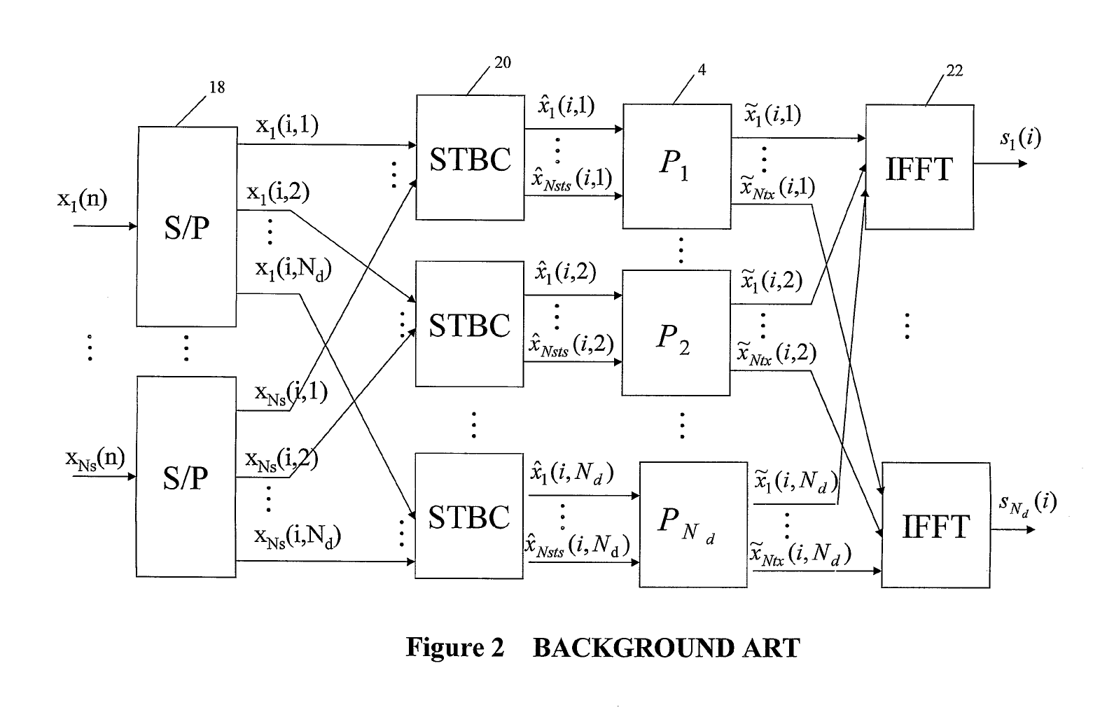

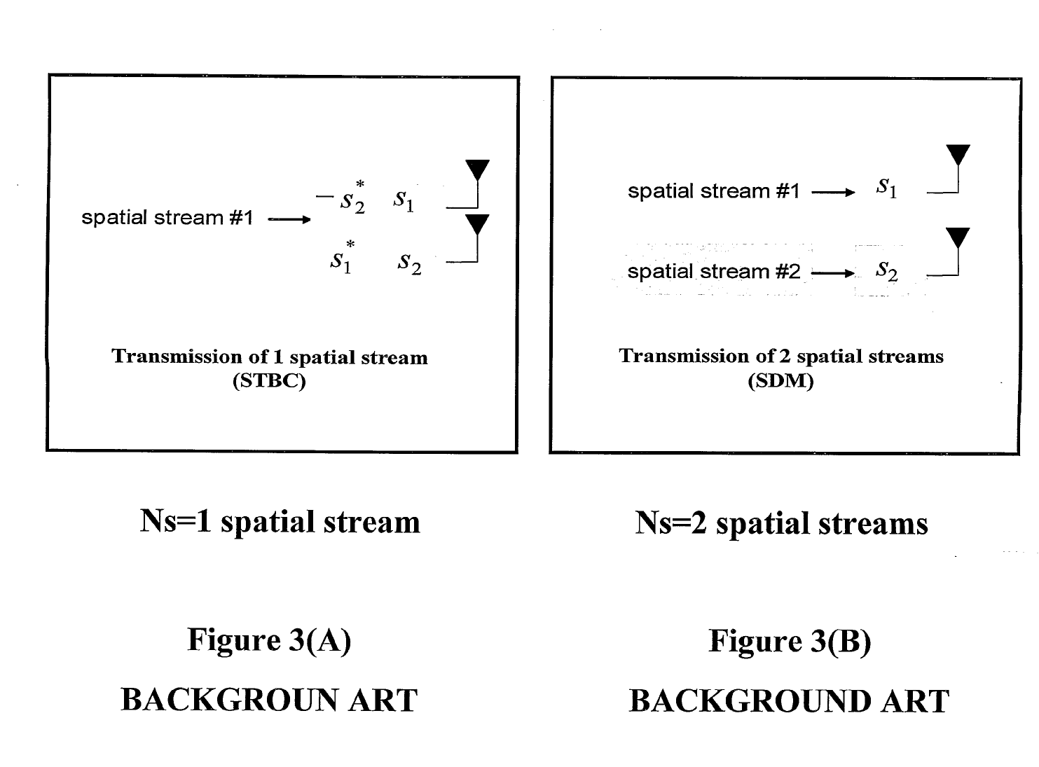

In still another embodiment, sub-carrier generating units (for example block 18) of the processing units feeding data streams to the mapping unit 4 may generate plural sub-carrier data streams and the mapping unit 4 may apply a plurality of matrices P, to the plural sub-carrier data streams (see for example FIG. 2) when the mapping unit is used in a transmitter or a transceiver. It is noted that the same plurality of matrices may be applied to the antenna streams received from the plurality of antennas 6 when the mapping unit is used in a receiver or a transceiver.

According to another embodiment of the invention, the time-dependent equivalent antenna mapping matrix is given by

\hat{P}(i)=S(i)P(i)T(i).

The equivalent channel matrix seen by the receiver portion of the other transceiver is an Ns by Nr matrix, where Nr is the number of the receiver antennas, and the Ns by Nr matrix is given by:

Ĥ(i)=\hat{P}(i)H=S(i)P(i)T(i)H.

Due to the time variance of the equivalent mapping matrix \hat{P}(i) in the transmitter portion 2, the channel “seen” by the receiver portion of the other transceiver also varies over the duration of the frame or the plural consecutive frames, even when the channel matrix H does not vary in time. This time variation of the matrix \hat{P} introduces the time diversity lacking in the conventional methods, which leads to an improved performance of the transmitter portion of the transceiver. All the properties discussed above with regard to the equivalent mapping matrix \hat{P} of the transmitter portion 2 equally apply to a mapping matrix used by any of a standalone receiver device or a receiver portion of another transceiver. It is noted that although the receiver portion is different than the transmitter portion, both of the receiver and transmitter portions may have an identical mapping matrix block. However, the S, P, and T matrices might be different at the receiver portion as illustrated in FIG. 6(D) than at the transmitter portion.

At the receiver portion of the other transceiver, the sets Ω, Φ, and Ψ and the permutation pattern are known as described above. However, if the pseudorandom sequence is used, each interval (chip duration) of the pseudorandom sequence leads to a new matrix (or matrices). These matrices belong to a larger set of Ω, Φ, and ψ, and lead to a different periodic permutation pattern.

If the matrix T(i) or the matrix P(i) is time varying, the receiver needs to estimate an Nt by Nr channel matrix H to track the Ĥ(i). However, in the conventional scheme, the receiver portion of the transceiver only needs to estimate the equivalent “channel matrix” P H, which is an Ns by Nr matrix. In some cases, Ns is less than Nt, which implies that the new scheme will introduce some estimation complexity when the matrix T(i) or the matrix P(i) is time-varying.

In order to avoid this increase in complexity, the matrices P and T can be fixed in time and only the matrix S(i) is allowed to vary in time according to the predefined pattern. In that case, the receiver portion of the other transceiver only needs to estimate the equivalent “channel matrix” P T H, which is also an Ns by Nr matrix.

The above described mapping method can be implemented in an apparatus for mapping signals in a wireless communications network. For example, the apparatus has a mapping unit 4 connected between a coder 10 and a plurality of antennas 6. The coder is configured to process a plurality of data streams in parallel and in which each data stream is partitioned into a plurality of frames and each frame includes a plurality of symbols. Each antenna is inserted in a wireless channel for carrying one of the plurality of streams. The mapping unit is configured to switch different symbols in the frames between different antennas and the coding unit according to the mapping matrix while each channel is carrying the corresponding data stream. The above described apparatus can be, for example, a transmitter, a receiver, or a transceiver.

### EXAMPLES

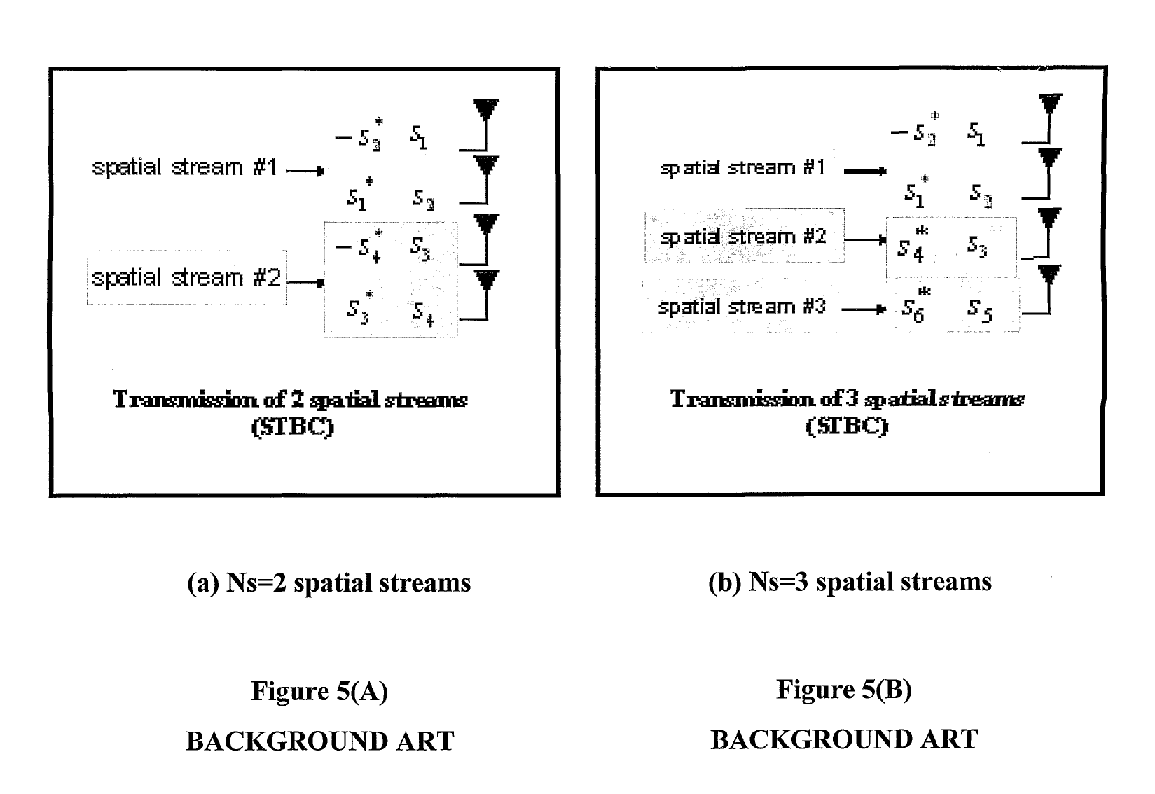

First, in FIG. 5(A), for the 4 transmit antennas, with Ns=2 spatial streams, and Nsts=4 space-time coded streams, the T and P matrices can be fixed to be 4×4 identity matrices. Thus, the set Ω consists of 3 elements defined as:

$$Ω = \{ \begin{matrix}{S}_{0} = [ \begin{matrix}1 & 0 & 0 & 0 \\ 0 & 1 & 0 & 0 \\ 0 & 0 & 1 & 0 \\ 0 & 0 & 0 & 1\end{matrix} ] , {S}_{1} = [ \begin{matrix}1 & 0 & 0 & 0 \\ 0 & 0 & 1 & 0 \\ 0 & 1 & 0 & 0 \\ 0 & 0 & 0 & 1\end{matrix} ] , \\ {S}_{2} = [ \begin{matrix}1 & 0 & 0 & 0 \\ 0 & 0 & 1 & 0 \\ 0 & 0 & 0 & 1 \\ 0 & 1 & 0 & 0\end{matrix} ]\end{matrix} \} .$$

One example of the predefined permutation pattern, which permutes through all the elements of Q, is:

S(i)=S_{mod(i,3)}.

Any known permutation that permutes through all the elements of Ω over the duration of the frame or plural consecutive frames can be used. Other permutation operations or methods for changing the value of the matrix S over the duration of the single frame (or over the duration of the plural consecutive frames) can be used as long as the receiver portion of the transceiver is made aware of, or learns by itself, the transmitter portion's predefined permutation pattern.

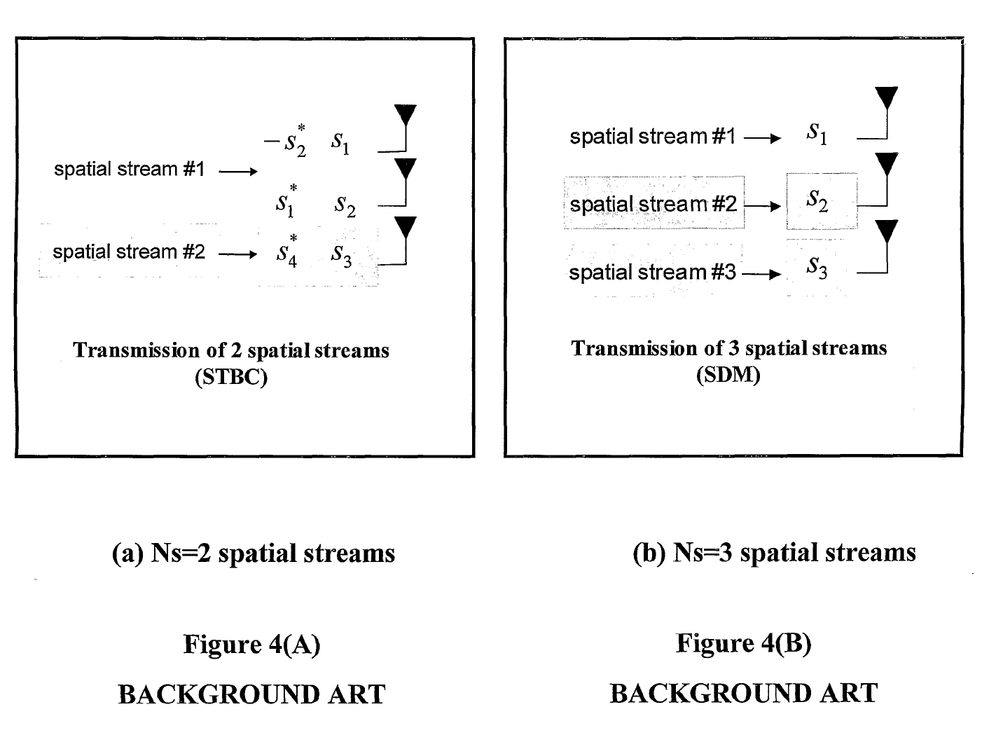

For the 3 transmit antennas, Ns=2 spatial streams, and Nsts=3 space-time coded streams case shown in FIG. 4(A), the permutation pattern is similar to the previous example. Thus, the set Ω can be defined as:

$$Ω = \{ \begin{matrix}{S}_{0} = [ \begin{matrix}1 & 0 & 0 \\ 0 & 1 & 0 \\ 0 & 0 & 1\end{matrix} ] , {S}_{1} = [ \begin{matrix}1 & 0 & 0 \\ 0 & 0 & 1 \\ 0 & 1 & 0\end{matrix} ] , \\ {S}_{2} = [ \begin{matrix}0 & 0 & 1 \\ 1 & 0 & 0 \\ 0 & 1 & 0\end{matrix} ]\end{matrix} \} .$$

For the 4 transmit antennas, 3 spatial streams, and 4 space-time coded streams case shown in FIG. 5(B), the set Ω and the permutation pattern can be defined similar to the one defined in the 4 transmit antennas and 2 spatial streams case.

In the above examples, all the S matrices are permutation matrices (having elements 1 or 0, with at most one element being 1 in any given row or column), which means that the S matrices only permute the input space-time coded spatial streams without affecting the weight that is attributed to the space-time coded spatial streams. Using permutation matrices in the antenna mapping block 4 has the advantage that the matrices do not need any changes for the AGC operation. The complexity of the channel estimation and other system design parameters are comparable with the conventional scheme, which does not use the time varying permutation according to the embodiments of the invention.

In multi-carrier communication systems, such as an 802.11n WLAN OFDM system, the new mapping method of the embodiment discussed with regard to FIG. 6(C) can be implemented at least in two ways:
[1] Space-time coded OFDM symbol block based: In this scheme, all the sub-carriers in the same space-time code OFDM symbol use the same permutation matrices S(i), P(i) and T(i), which are only functions of the space-time coded OFDM block index i. The above examples are based on this scheme.
[2] Sub-carrier based: In this scheme, different sub-carriers in the same space-time coded OFDM symbol block use different permutation matrices S(i, k), P(i, k) and T (i, k), which are the functions of both the space-time coded OFDM block index i and the sub-carrier index k. For example, for the sub-carrier based schemes, the following predefined permutation pattern can be used:

S(i,k)=S_{mod(i+k,3)}.

Other predefined permutation patterns can be used as discussed above.

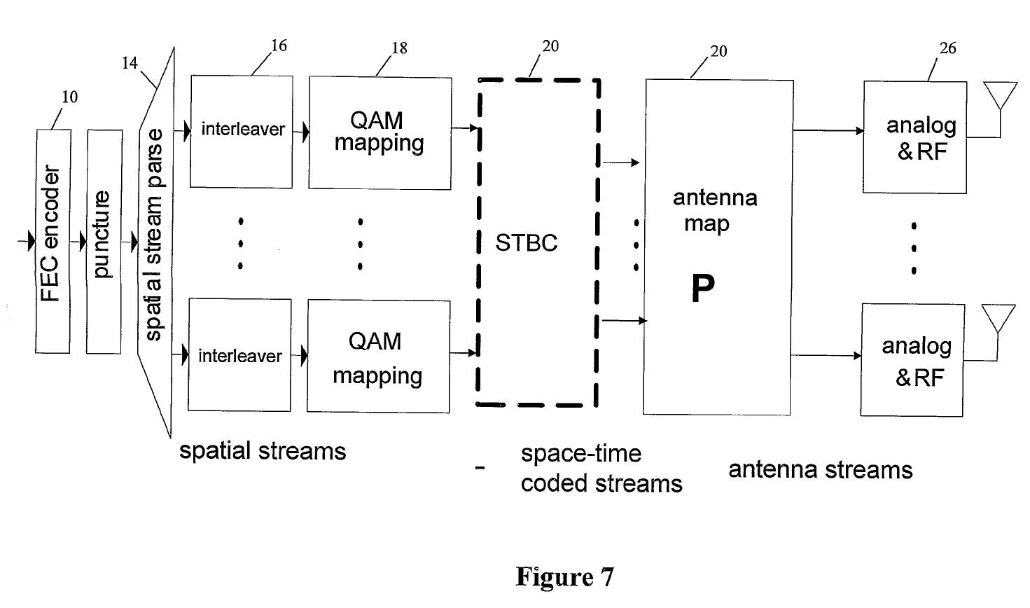

The new method of mapping can be also used for single carrier MIMO systems. For example, a single carrier MIMO system may have the transmitter portion as shown in FIG. 7. The predefined permutation pattern defined in the above example can be used directly for this single carrier MIMO system.

There are possible variations of the above discussed mapping method. The approach proposed above can be used for both single carrier and multi-carrier MIMO systems, which include the WiMax 802.16 systems, WLAN 802.11n systems, 3GPP and other communication systems. Although in the above discussed examples, only permutation matrices have been used, any unitary, or even non-singular matrices can be used as S, T and P matrices of the new mapping method.

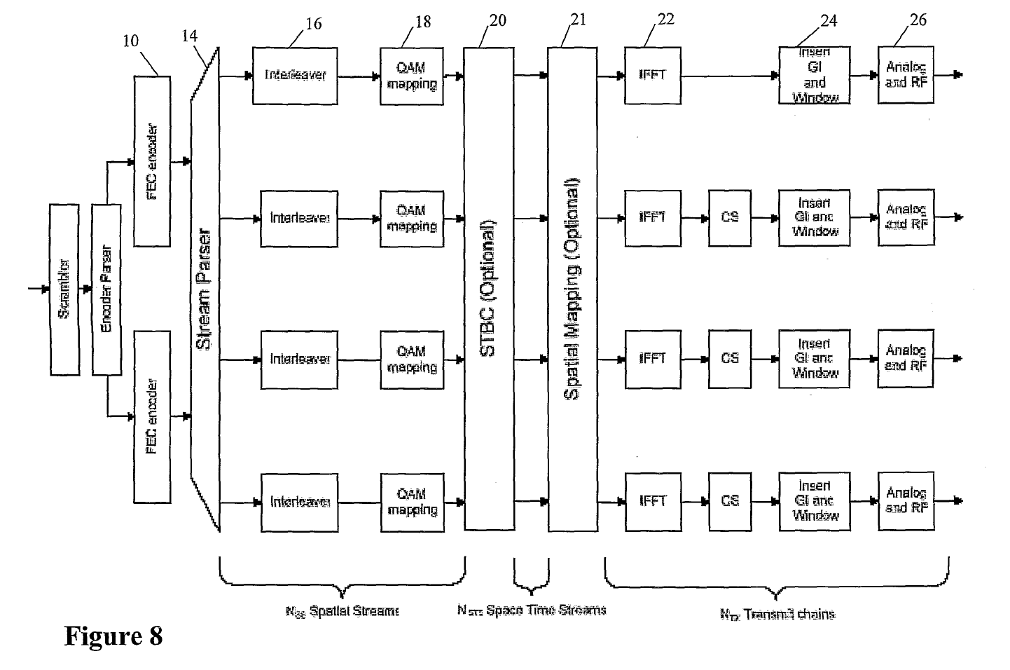

While the block diagrams of FIGS. 6(A)-7 show only one channel code, the mapping method is also applicable to transmitter portions with multiple codewords. One example of such transmitter portion with multiple codewords is shown in FIG. 8, which is applicable for two or more spatial streams cases.

The new mapping method can be also applied to other system configurations and other space-time coding or spatial multiplexing schemes, for example, BLAST systems with independent channel encoded for different spatial streams, and/or other systems know to one of ordinary skill in the art.

### Simulations Results

Simulation results are shown below to illustrate the performance advantage of the scheme of the present invention.

1. Case 1—Single carrier MIMO system simulation results.

The structure used for this simulation is shown in FIG. 7 and an antenna hopping pattern can be any of the predefined permutation patterns given in the above examples. The simulation parameters are listed as follow:

| | |
|---|---|
| Channel Model | i.i.d. Rayleigh flat fading channel |
| Number of TX | 4 |
| Number of RX | 2 |
| STBC | See FIG. 5(A) |
| Demodulator | LMMSE soft demodulator without SIC |
| FEC | ½, ¾ LDPC codes |
| FEC decoder | BP soft decoder with 30 iterations |
| Channel seeds | 10000 |
| Modulation | 16QAM |

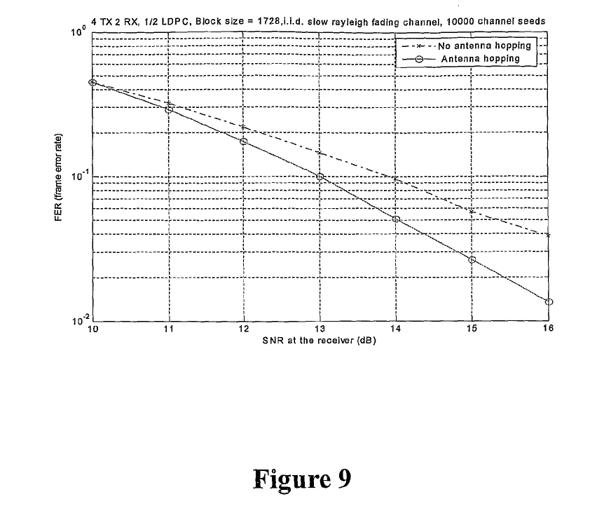

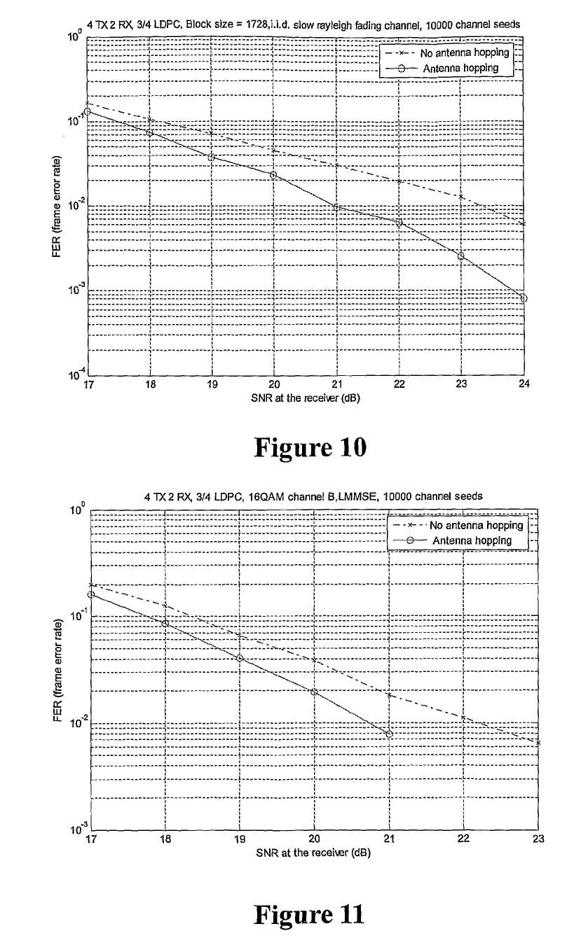

From the slopes of the FER (frame error rate) curves shown in FIG. 9, it can be seen that the new scheme achieves a higher diversity gain compared with the conventional scheme without antenna hopping. In this configuration, the new scheme achieves about more than 1.5 dB gain at a frame error rate of 0.01. For ¾ LDPC coded case shown in FIG. 10, the new scheme can achieve about 2.3 dB gain at the frame error rate of 0.01.

### 2. Case 2. MIMO-OFDM System Simulation Results

The structure of the system used in this simulation is shown in FIG. 6(C) and the antenna hopping pattern can be any of the patterns given in the above examples. The simulation parameters are listed as follow:

| | |
|---|---|
| Channel Model | TGn channel B |
| Number of TX | 4 |
| Number of RX | 2 |
| STBC | See FIG. 5(A) |
| Demodulator | LMMSE soft demodulator without SIC |
| FEC | ½, ¾ LDPC codes and |
| | convolutional codes |
| FEC decoder | BP soft decoder with 30 iterations for LDPC and |
| | softViterbi for CC |
| Channel seeds | 10000 |
| Modulation | 16QAM |

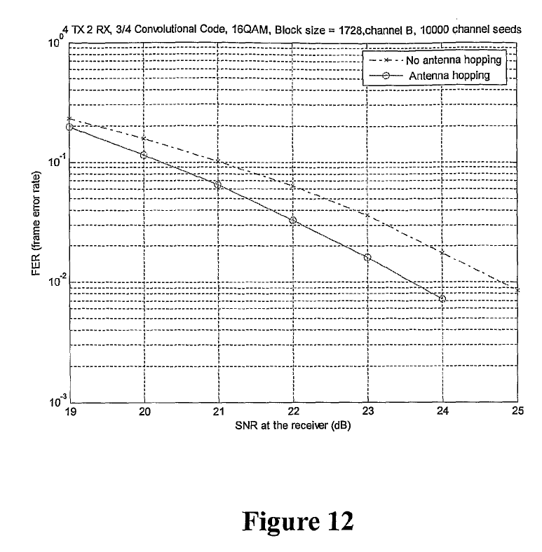

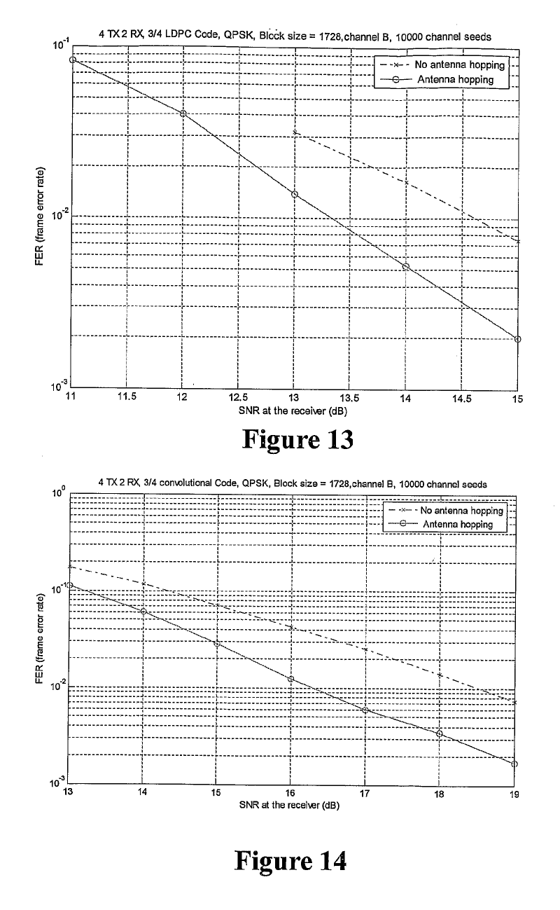

From the simulation results shown in FIG. 11, it can be seen that the new scheme achieves more than 1 dB gain for all modulation coding settings (MCS) comparative to the situation without antenna hopping. Similarly, FIGS. 12-14 show the gain achieved by the various embodiments of the present invention when quadraphase-shift modulation is used.

The present invention includes processing of a signal input to the transmitter portion or received at the receiver portion, and programs by which the input signal is processed. Such programs are typically stored and executed by a processor in a mobile wireless receiver/transmitter/transceiver implemented in VLSI. The processor typically includes at least processor storage product, i.e., an electronic storage medium, for storing program instructions containing data structures, tables, records, etc. Examples are storage media, electronic memories including PROMs (EPROM, EEPROM, flash EPROM), DRAM, SRAM, SDRAM, FRAM, or any other magnetic medium, or any other medium from which a processor can read, for example compact discs, hard disks, floppy disks, tape, magneto-optical disks.

The electronic storage medium according to one embodiment of the invention may include one or a combination of processor readable media, to store software employing computer code devices for controlling the processor. The processor code devices may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

Numerous modifications and variations of the present invention are possible in light of the above teachings. It is therefore to be understood that within the scope of the appended claims, the invention may be practiced otherwise than as specifically described herein.

1. A MIMO (multiple-input multiple-output) communication method for wireless communication, comprising:
mapping symbols during a duration of each plural consecutive frames of each of a plurality of first data streams to frames of a plurality of second data streams; and
varying the mapping during the duration of each of the plural consecutive frames of each of the plurality of first data streams.

2. The method of claim 1, comprising:
encoding an input signal to generate the plurality of first data streams.

3. The method of claim 2, comprising:
converting the plurality of second data streams to time domain signals to be applied to a plurality of antennas.

4. The method of claim 1, comprising:
receiving signals from a plurality of antennas and converting the received signals into the frequency domain to produce the plurality of first data streams.

5. The method of claim 4, further comprising:
decoding the second data streams after the mapping.

6. The method of claim 1, wherein:
when transmitting an input signal via a plurality of antennas, encoding an input signal to generate the plurality of first data streams, and when receiving signals by the plurality of antennas, converting the received signals from the plurality of antennas to frequency domain signals to produce the plurality of first data streams from the plurality of antennas.

7. The method of claim 6, further comprising:
when transmitting the input signal via the plurality of antennas, converting the mapped second data streams to time domain data streams applied to the plurality of antennas, and, when receiving the signals from the plurality of antennas, decoding the mapped second data streams.

8. The method of claim 1, wherein the mapping step comprises:
mapping the symbols within each of the plural consecutive frames of each of the first data streams based on a combination of a mapping matrix and at least one of a space-time coded spatial stream permutation matrix and a transmit antenna permutation matrix.

9. The method of claim 8, wherein the varying step comprises:
varying one or more of the mapping matrix, the space-time coded spatial stream permutation matrix, and the transmit antenna permutation matrix during the duration of each of the plural consecutive frames.

10. The method of claim 1, wherein the mapping step comprises:
performing closed loop mapping of each first data stream.

11. The method of claim 1, wherein the mapping step comprises:
mapping the symbols of the plurality of first data streams based on a non-singular matrix.

12. The method of claim 1, wherein the mapping step comprises:
mapping the symbols of the plurality of first data streams based on a unitary or a semi-unitary matrix.

13. The method of claim 1, wherein the varying step comprises:
permuting one or more of the mapping matrix, the space-time coded spatial stream permutation matrix, and the transmit antenna permutation matrix over the duration of each of the plural consecutive frames.

14. The method of claim 1, wherein the varying step comprises:
varying one or more of the mapping matrix, the space-time coded spatial stream permutation matrix, and the transmit antenna permutation matrix over the duration of each of plural consecutive frames at least twice.

15. The method of claim 1, wherein the varying step comprises:
varying one or more of the mapping matrix, the space-time coded spatial stream permutation matrix, and the transmit antenna permutation matrix with a periodicity that extends over at least two consecutive frames.

16. The method of claim 1, wherein:
the mapping step comprises generating plural sub-carrier data streams and mapping the plural sub-carrier data streams with a plurality of matrices.

17. A MIMO (multiple-input multiple-output) communication device for wireless communication, comprising:
a plurality of antennas;
plural processing devices coupled to the plurality of antennas; and
a mapping unit configured to map symbols within each frame of a plurality of data streams between different antennas and the processing units and configured to varyingly map the symbols during a duration of each of plural consecutive frames.

18. The device of claim 17, in which the processing units comprise encoders configured to encode the symbols, and the antennas transmit the mapped symbols.

19. The device of claim 17, in which the plurality of antennas receive the symbols, and the processing units comprise decoders configured to decode the symbols.

20. The device of claim 17, in which the mapping unit is configured to time varyingly map the symbols with a periodicity that extends over at least two consecutive frames.

21. The device of claim 17, wherein:
the processing units, when transmitting an input signal via the plurality of antennas, comprise,
an encoder configured to encode an input signal to generate the plurality of data streams, and
a conversion unit configured to convert the mapped symbols into time domain data streams applied to the plurality of antennas; and
the processing units, when receiving signals from the plurality of antennas, comprise,
conversion units configured to convert the received signals received by the plurality of antennas into frequency domain signals to generate the plurality of data streams for mapping by the mapping unit, and
a decoder configured to decode the symbols subjected to mapping by the mapping unit.

22. The device of claim 17, wherein the mapping unit comprises:
a matrix combining unit configured to map the symbols within each of the plural consecutive frames of each of the plurality of data streams based on a combination of a mapping matrix and at least one of a space-time coded spatial stream permutation matrix and a transmit antenna permutation matrix.

23. The device of claim 22, wherein the matrix combining unit is configured to vary one or more of the mapping matrix, the space-time coded spatial stream permutation matrix, and the transmit antenna permutation matrix over the duration of each of the plural consecutive frames of the plurality of first data streams.

24. The device of claim 17, wherein the mapping unit comprises:
a closed loop mapping unit configured to perform closed loop mapping of each symbol.

25. The device of claim 17, wherein the mapping unit comprises:
a non-singular mapping unit configured to map the symbols of the plurality of data streams based on a non-singular matrix.

26. The device of claim 17, wherein the mapping unit comprises:
a unitary or semi-unitary mapping unit configured to map the symbols of the plurality of data streams based on a unitary or a semi-unitary matrix.

27. The device of claim 17, wherein the mapping unit comprises:
a permuting unit configured to permute at least one of the mapping matrix, the space-time coded spatial stream permutation matrix, and the transmit antenna permutation matrix within the duration of each of the plural consecutive frames.

28. The device of claim 17, wherein the mapping unit is configured to vary the at least one matrix at least twice during the duration of each of the plural consecutive frames.

29. The device of claim 17, wherein:
the processing units comprise sub-carrier generating units configured to generate plural sub-carrier data streams; and
the mapping unit comprises sub-carrier mapping units configured to map symbols of the plural sub-carrier data streams with a plurality of matrices.

30. A MIMO (multiple-input multiple-output) communication device for wireless communication, comprising:
a plurality of antennas;
plural processing devices coupled to the plurality of antenna; and
means for mapping symbols within each frame of a plurality of data streams between different antennas and the processing units and for varyingly mapping the symbols during a duration of each of plural consecutive frames.

31. A MIMO (multiple-input multiple-output) method of wireless communication via a plurality of antennas, comprising:
mapping symbols during a duration of each plural consecutive frames of each of a plurality of first data streams to frames of a plurality of second data streams; and
a step of varying the mapping during the duration of each of the plural consecutive frames of each of the plurality of first data streams.

32. An electronic storage medium storing program instructions which when executed by a processor in a MIMO (multiple-input multiple-output) communication device for wireless communication system, causes the processor to execute the steps comprising:
mapping symbols during a duration of each plural consecutive frames of each of a plurality of first data streams to frames of a plurality of second data streams; and
varying the mapping during the duration of each of the plural consecutive frames of each of the plurality of first data streams.

33. A MIMO (multiple-input multiple-output) method of wireless communication via a plurality of antennas, comprising:
generating a plurality of first data streams, in which each first data stream includes a plurality of frames, and in which each frame includes a plurality of symbols;
mapping symbols within each of plural consecutive frames of each of the first data streams to frames of a plurality of second data streams based on at least one matrix, including a mapping matrix; and
varying the at least one matrix over a duration of each of the plural consecutive frames of the plurality of first data streams to vary mapping of the plurality of symbols of each of the plural consecutive frames of the plurality of first data streams to different of the plurality of second data streams, and in which one of the first and second data streams is coupled to the plurality of antennas.
